(19) United States
(12) Patent Application Publication
(10) Pub. No.: US 2025/0265134 A1
(43) Pub. Date: Aug. 21, 2025

(54) METHOD OF ASSISTING AN ADMINISTRATIVE USER WITH PROVIDING A REMOTE TELEPHONY ENVIRONMENT USING DISTRIBUTED COMPUTING

(71) Applicant: CDW LLC, Vernon Hills, IL (US)

(72) Inventors: Michael Alan Robinson, Clinton, OH (US); Kristofor M. Seraphine, Cottage Grove, WI (US); Christopher Deren, Itasca, IL (US)

(21) Appl. No.: 19/058,772

(22) Filed: Feb. 20, 2025

Related U.S. Application Data
(60) Provisional application No. 63/556,350, filed on Feb. 21, 2024.

(51) Int. Cl. G06F 9/54; H04L 9/40

(52) U.S. Cl. CPC G06F 9/547; H04L 63/08

(57) ABSTRACT

A method, system and computer-readable medium for assisting an administrative user with providing a remote telephony environment may include generating, by one or more processors, an organization credential corresponding to a customer; importing, via an electronic network, a provisioning workbook corresponding to a remote telephony environment; processing, by the one or more processors, the provisioning workbook, wherein the processing includes transforming the provisioning workbook into an application programming interface (API) call corresponding to the remote telephony environment; generating, by the one or more processors, configuration data corresponding to the provisioning workbook; and transmitting, to a customer tenant via the electronic network, the API call corresponding to the remote telephony environment.

### CROSS-REFERENCE TO RELATED APPLICATIONS

This application claims the benefit of U.S. Provisional Patent Application No. 63/556,350, filed Feb. 21, 2024, and entitled “Method of Assisting an Administrative User With Providing a Remote Telephony Environment Using Distributed Computing”, which is incorporated herein by reference in its entirety.

### TECHNICAL FIELD

The present disclosure is generally directed to methods and systems for assisting an administrative user with providing a remote telephony environment, and more particularly, to importing a provisioning workbook, transforming the provisioning workbook to an application programming interface (API) call, and transmitting the API call to a cloud services provider.

### BACKGROUND

In the field of Unified Communications as a Service (UCaaS) and Contact Center as a Service (CCaaS) provisioning, there are several challenges and limitations associated with conventional techniques. For example, conventional techniques typically involve manual data entry of customer information and data associated with their organization, which is time-consuming, error-prone, and inefficient. Manual data entry not only increases the preparation time but also leads to a significant amount of manual effort required for data input. The manual nature of conventional techniques also lacks consistency and adherence to any form of standards and/or best practices. Additionally, the use of conventional techniques results in slower customer installations and migrations between platforms. This slower installation process not only delays the deployment of UCaaS and CCaaS solutions but also increases costs for customers. The lack of a unified platform for managing multiple vendors' UCaaS and CCaaS clients further complicates the provisioning process. Similar deficiencies exist in other areas too.

These conventional problems present opportunities for improved platforms and technologies to address them. There exists a need for a solution that streamlines the provisioning process, reduces manual data entry, enforces standards and best practices, and provides a unified interface for managing multiple UCaaS and CCaaS vendors there by enabling quicker, more efficient, and more accurate deployments of UCaaS and CCaaS solutions, resulting in cost savings for customers.

### BRIEF SUMMARY

In one aspect, a computer-implemented method for assisting an administrative user with providing a remote telephony environment includes (1) generating, by one or more processors, an organization credential corresponding to a customer, (2) importing, via an electronic network, a provisioning workbook corresponding to a remote telephony environment, (3) processing, by the one or more processors, the provisioning workbook, wherein the processing includes transforming the provisioning workbook into an application programming interface (API) call corresponding to the remote telephony environment, (4) generating, by the one or more processors, configuration data corresponding to the provisioning workbook, and (5) transmitting, to a customer tenant via the electronic network, the API call corresponding to the remote telephony environment.

In another aspect, a computing system for assisting an administrative user with providing a remote telephony environment. The system may include one or more processors; and one or more memories having stored thereon instructions that, when executed by the one or more processors, cause the system to (1) generate, by the one or more processors, an organization credential corresponding to a customer, (2) import, via an electronic network, a provisioning workbook corresponding to a remote telephony environment, (3) process, by the one or more processors, the provisioning workbook, wherein the process includes transforming the provisioning workbook into an application programming interface (API) call corresponding to the remote telephony environment, (4) generate, by the one or more processors, configuration data corresponding to the provisioning workbook, and (5) transmit, to a customer tenant via the electronic network, the API call corresponding to the remote telephony environment.

In yet another aspect, a non-transitory computer-readable medium having stored thereon computer-executable instructions for assisting an administrative user with providing a remote telephony environment that, when executed, cause a computer to (1) generate, by one or more processors, an organization credential corresponding to a customer, (2) import, via an electronic network, a provisioning workbook corresponding to a remote telephony environment, (3) process, by the one or more processors, the provisioning workbook, wherein the process includes transforming the provisioning workbook into an application programming interface (API) call corresponding to the remote telephony environment, (4) generate, by the one or more processors, configuration data corresponding to the provisioning workbook, and (5) transmit, to a customer tenant via the electronic network, the API call corresponding to the remote telephony environment.

In one aspect, a computer-implemented method for assisting an administrative user with providing a remote telephony environment includes a provisioning workbook and configuration data including an action of at least one of: creating, updating, deleting, or ignoring.

In another aspect, a computer-implemented method for assisting an administrative user with providing a remote telephony environment includes importing, via an electronic network, an audio prompts file.

In yet another aspect, a computing system for assisting an administrative user with providing a remote telephony environment includes an organization credential including at least one of an OAuth or a refresh token.

In another aspect, a computing system for assisting an administrative user with providing a remote telephony environment includes one or more processors; and one or more memories having stored thereon instructions that, when executed by the one or more processors, cause the system to: search, by the one or more processors, the configuration data corresponding to the provisioning workbook, generate, by the one or more processors, an event history, and export, by the one or more processors, a provisioning workbook.

In yet a further aspect, a non-transitory computer-readable medium includes computer-executable instructions that, when executed, cause a computer to generate, by one or more processors, a details page with an outcome of the transmission.

In another aspect, a computer-implemented method for assisting an administrative user with providing a remote telephony environment includes a provisioning workbook and configuration data including at least one of: entry points, queues, skill profiles, skills, teams, common areas, devices, emergency locations, phone numbers, phone users, sites, templates, meeting users, dispositions, prompts, users, permission profiles, or data.

### BRIEF DESCRIPTION OF THE FIGURES

The figures described below depict various aspects of the system and methods disclosed therein. It should be understood that each figure depicts one aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

FIG. 1 depicts an exemplary computing environment in which the techniques disclosed herein may be implemented, according to some aspects.

FIG. 2A depicts an exemplary provisioning workbook, according to some aspects.

FIG. 2B depicts an exemplary supported attributes help sheet, according to some aspects.

FIG. 3 depicts an exemplary computer-implemented method in which the techniques disclosed herein may be implemented, according to some aspects.

FIG. 4A depicts an exemplary organization credential user interface, according to some aspects.

FIG. 4B depicts an exemplary computer-implemented method of organization credential creation, according to some aspects.

FIG. 5A depicts an exemplary provisioning workbook import, according to some aspects.

FIG. 5B depicts an exemplary computer implemented method of importing a provisioning workbook, according to some aspects.

FIG. 6A depicts exemplary configuration data corresponding to the exemplary provisioning workbook of FIG. 2A, according to some aspects.

FIG. 6B depicts an exemplary configuration data transmission, according to some aspects.

FIG. 6C depicts an exemplary computer implemented method of configuration data transmission, according to some aspects.

FIG. 7A depicts an exemplary searching user interface, according to some aspects.

FIG. 7B depicts an exemplary events history user interface, according to some aspects

FIG. 7C depicts an exemplary export user interface and provisioning workbook, according to some aspects.

FIG. 7D depicts an exemplary computer implemented method of provisioning workbook exporting, according to some aspects.

The figures depict preferred aspects for purposes of illustration only. One skilled in the art will readily recognize from the following discussion that alternative aspects of the systems and methods illustrated herein may be employed without departing from the principles of the invention described herein.

### DETAILED DESCRIPTION

### Overview

The present techniques provide methods and systems for, inter alia, assisting an administrative user with providing a remote telephony environment using distributed computing. A multi-brand provider of information technology solutions to customers in the business, government, education, and healthcare industries may provide a broad array of products and services ranging from hardware and software to integrated information technology solutions such as contact center unified communication services, security, cloud computing, hybrid infrastructure and digital experience. The IT solutions provider may use the present techniques to enable an administrative user to provide a remote telephony environment. The present techniques address the inefficiencies and data-intensive nature of managing Unified Communications as a Service (UCaaS) and Contact Center as a Service (CCaaS). The present techniques, utilizing distributed computing to generate API keys in parallel advantageously improves the efficiency and speed of API key generation, thereby reducing processing times and minimizing the consumption of computing resources. By enabling the simultaneous generation of multiple API keys, the present techniques enable more efficient integration and management of UCaaS and CCaaS services, facilitating a seamless and scalable experience thereby enabling quicker, more efficient, and accurate deployments.

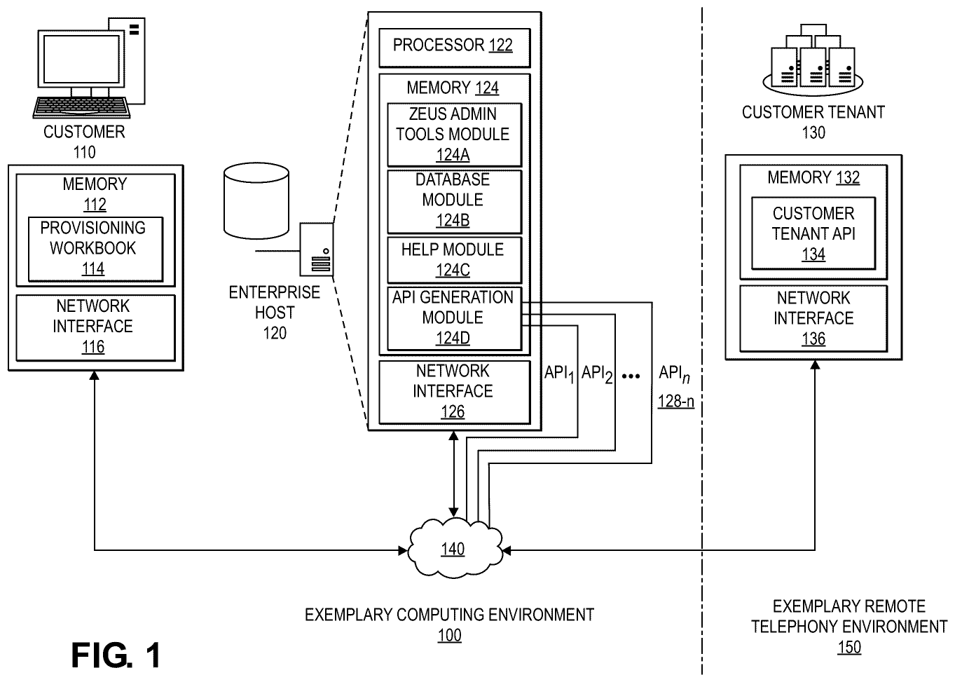

As previously mentioned, the present techniques may include methods and systems for providing a remote telephony environment. To provide a better understanding of the systems and methods described herein, FIG. 1 depicts an exemplary computing environment in which techniques of the present disclosure may be implemented, according to some aspects. As described, the present techniques improve conventional systems by, inter alia, providing a faster and more accurate deployment of a customer's cloud collaboration solutions. These techniques may simplify the cloud deployment process and achieve greater speed and accuracy than conventional techniques. The present techniques may include software that may be stored and executed by a host server. This software may include modules, web tools, application programming interfaces (API), etc. that allow customers to deploy their cloud collaboration solutions. The present techniques are applicable to additional use cases/environments.

The present techniques may include creating an organization credential corresponding to a customer. The organization credential may require an OAuth and/or a refresh token. The technique may include receiving, from a customer, a provisioning workbook including customer attributes (e.g., users, devices, and interactive voice response's (IVR's)), among other information. The provisioning workbook may be imported to a Zeus admin tools module. An API generation module may processes the provisioning workbook and generate an API call corresponding to the provisioning workbook imported, and the Zeus admin tools module may process the provisioning workbook and generate configuration data corresponding to the provisioning workbook. The API call may be transmitted to a customer tenant API thereby streamlining the cloud deployment process.

For example, the present techniques may be achieved by code in Python and utilize Python Flask as a web application framework. The present techniques may be implemented utilizing Bootstrap for a user interface, HTMX as an HTML plugin, and MkDocs for help documentation. The present techniques may be implemented as a Docker container hosted on a Linux operating system.

### Exemplary Computing Environment

FIG. 1 depicts an exemplary computing environment 100 in which various embodiments and/or techniques of the present disclosure may be implemented, in some aspects. Generally, the exemplary computing environment 100 may be or include the various computing devices and/or components that execute some/all of the functions described herein. The environment 100 may include a customer 110, an enterprise host 120, a customer tenant 130, an electronic network 140, and an exemplary remote telephony environment 150.

The electronic network 140 may be a single communication network, or may include multiple communication networks of one or more types (e.g., one or more wired and/or wireless local area networks (LANs), and/or one or more wired and/or wireless wide area networks (WANs) such as the Internet). The electronic network 140 may enable bidirectional communication between the enterprise host 120 and the various components of an IT solutions providers computing environment (e.g., the customer 110, the customer tenant 130, etc.)

### Exemplary Customer

The customer 110 may be any number of individuals, business', government's, education/healthcare provider's, etc. in need of UCaaS and/or CCaaS for deployment of their cloud collaboration solutions. The customer 110 may be located anywhere and may be embodied by various computing devices such as a smartphone, a tablet, a laptop, a desktop computer, etc. In some embodiments the customer 110 may include aspects of one or more of the foregoing in combination, such as smartphone tablet combination (e.g., a phablet) or a tablet laptop combination (e.g., a 2-in-1 tablet laptop), etc.

The customer 110 may include a memory 112, a provisioning workbook 114, and a NIC (Network Interface Card) 116. The memory 112 may include one or more persistent memories (e.g., a hard drive/solid state memory) and may store the provisioning workbook 114. The NIC 116 of the customer 110 may include any suitable network interface controller(s), such as wired/wireless controllers (e.g., cellular wireless controllers, Ethernet controllers, etc.), and facilitate bidirectional/multiplexed networking over the network 140 between the customer 110 and other components of the exemplary computing environment 100.

In one aspect, the customer 110 may be an organization in need of a cloud collaboration solution from a customer tenant 130 (e.g., Zoom Contact Center, Zoom Phone, Webex Contact Center, Webex Calling, Five9 Contact Center, Microsoft Teams, etc.). An employee of the organization (e.g., an IT director/coordinator) may fill in the provisioning workbook 114 with attributes of their organization (e.g., users, devices, IVR's, etc.). The customer 110 may transmit the provisioning workbook 114 to the enterprise host 120 via the network 140.

In another aspect, the customer 110 may be and/or include a computing device associated with (e.g., owned/operated by) the IT solutions provider (e.g., a company that services enterprise customers) and may include software licensed from a third party.

In yet another aspect, the provisioning workbook 114 may be a spreadsheet (e.g., a Microsoft Excel spreadsheet). The provisioning workbook may have various provisioning tabs (e.g., entry points, queues, skill profiles, skills, teams, common areas, devices, emergency locations, phone numbers, phone users, sites, templates, meeting users, dispositions, prompts, users, permission profiles, data, etc.) corresponding to a particular customer tenant. For example, the provisioning workbook 114 for use by Webex Contact Center may have one set of provisioning tabs (e.g., skills, skill profiles, teams, entry points, queues) while another cloud solutions provider (e.g., Zoom Contact Center) may have a different set of provisioning tabs (e.g., common areas, devices, emergency locations, phone numbers, phone users, sites, templates, meeting users).

In another aspect, the provisioning workbook 114 may include various provisioning tabs (e.g., entry points, queues, skill profiles, skills, teams, common areas, devices, emergency locations, phone numbers, phone users, sites, templates, meeting users, dispositions, prompts, users, permission profiles, data, etc.) that are filled with customer attributes such as: a user name, email, first name, last name, extension, permissions, name, description, type, use timer, attempts, timer, message of the day, voicemail, active, service level agreement (SLA), skills, channel type, entry point type, time zone, overflow number, subscription ID, maximum active contacts, control flow, queue type, agents, skill profile name, multimedia profile name, desktop layout name, capacity, directory number (DN), site name, team type, team status, new extension, phone numbers, site, calling plans, address line 1, address line 2, city, state, zip, country, MAC address, new MAC address, template, assignee, new name, parent location, public IP, private IP, basic service set identifier (BSSID), emergency location information number (ELIN), strict match, license type, department, role, company, job title, language, location, manager, pronouns, pronouns option, voicemail enable, transfer site, auto receptionist, voicemail enable, call forwarding enable, call forwarding type, or any other similar customer attribute.

In another aspect, one provisioning tab (e.g., skills) may have a particular set of customer attributes associated with it (e.g., action, name, description, active, type, and SLA) based on the customer tenant (e.g., Webex Contact Center) while a second provisioning tab (e.g., skills) for another customer tenant (e.g., Five9) may have another set of customer attributes (e.g., name, description, message of the day, and voicemail) associated with the provisioning tab despite sharing the same provisioning tab name. Moreover, two different provisioning tabs for the same or different customer tenants may contain the same or different customer attributes depending on the customer tenant 130 and configuration.

### Exemplary Enterprise Host

The enterprise host 120 may include one or more processors 122, a memory 124, and a NIC (Network Interface Card) 126. The processor 122 may include any suitable number of processors and/or processor types, such as CPUs and one or more graphics processing units (GPUs). Generally, the processor 122 is configured to execute software instructions stored in the memory 124. The memory 124 may include one or more persistent memories (e.g., a hard drive/solid state memory) and stores one or more sets of computer executable instructions/modules. The NIC 126 may include any suitable network interface controller(s), such as wired/wireless controllers (e.g., cellular wireless controllers, Ethernet controllers, etc.), and facilitate bidirectional/multiplexed networking over the network 140 between the enterprise host 120 and other components of the exemplary computing environment 100. The memory 124 may include a Zeus admin tools module 124a, a database module 124b, a help module 124c, and an API generation module 124d.

In one aspect, the enterprise host 120 may be an individual server, a group (e.g., cluster) of multiple servers, or another suitable type of computing device or system (e.g., a collection of computing resources). For example, the enterprise host 120 may be any suitable computing device (e.g., a server, a personal computer (PC), a workstation, etc.).

Each of the modules 124a, 124b, 124c, and 124d implements specific functionality related to the present techniques, as will be described further below. In some aspects, the modules 124a, 124b, 124c, and 124d may work in concert to implement a particular technique. For example, the Zeus admin tools module 124a may work with the database module 124b and API generation module 124d because the Zeus admin tools module 124a may import a provisioning workbook 114, the database module 124b may store the provisioning workbook, the API generation module 124d may process the provisioning workbook and may generate an API call 128-n corresponding to the provisioning workbook, the database module 124b may store the API call 128-n. Thus, the modules 124a, 124b, and 124d may exchange data via suitable techniques, e.g., within a single computing device/system, such as the enterprise host 120 (as configured in some aspects). Or, in aspects wherein the exemplary computing environment 100 is implemented using multiple components (e.g., multiple enterprise hosts), a first enterprise host may perform the importing functionality, while another performs the storing functionality. That is, the modules 124a, 124b, 124c, and 124d may be redistributed across multiple computing devices/memories, for scaling purposes or for other purposes.

The modules 124a, 124b, 124c, and 124d of FIG. 1 will now be described in greater detail.

Generally, the Zeus admin tools module 124a includes instructions that enable an administrative user (e.g., an employee of the IT solutions provider, a software developer, etc.) to provide a remote telephony environment. The Zeus admin tools module 124a may include instructions for creating an organization credential. The organization credential may include authenticating via one or more authentication methods (e.g., OAuth, refresh tokens, OpenID Connect, etc.). For example, the Zeus admin tools module 124a may include software libraries for accessing the IT solutions provider's authentication databases/directories. The Zeus admin tools module 124a may authenticate via API authentication methods (e.g., via cookies, public key certificates, etc.). In some aspects (e.g., multi-factor authentication aspects), the Zeus admin tools module 124a may receive one-time use passwords from a particular customer and/or a particular customer tenant (e.g., Zoom Contact Center, Zoom Phone, Webex Contact Center, Webex Calling, Five9 Contact Center, Microsoft Teams, etc.).

The Zeus admin tools module 124a may include instructions that enable the administrative user (e.g., an employee of the IT solutions provider, a software developer, etc.) to import a provisioning workbook. In general, the provisioning workbook may be a spreadsheet (e.g., a Microsoft Excel spreadsheet) containing attributes (e.g., users, devices, IVR's, etc.) about a particular customer. In some aspects, the import may include an audio prompts file which may include pre-recorded audio clips used by an IVR system to guide callers through automated menus, provide information, and/or collect input, among other functionality.

The Zeus admin tools module 124a may process the imported provisioning workbook. The Zeus admin tools module 124a may parse the rows and columns of the provisioning workbook which may be a spreadsheet (e.g., a Microsoft Excel spreadsheet) and the Zeus admin tools module 124a may generate configuration data corresponding to the provisioning workbook so that the administrative user may review before transmitting an API call 128-n to the customer tenant 130.

In one aspect, the Zeus admin tools module 124a may create an organization credential corresponding to a customer, import a provisioning workbook, process the provisioning workbook, generate configuration data corresponding to the provisioning workbook, and transmit an API call 128-n to a customer tenant 130.

In another aspect, the Zeus admin tools module 124a may create an organization credential corresponding to a customer, import a provisioning workbook, process the provisioning workbook, generate configuration data corresponding to the provisioning workbook. That is the Zeus admin tools module 124a may not transmit the API call 128-n to a customer tenant 130 because another module (e.g., the API generation module 124d) may transmit the API call 128-n to the customer tenant 130.

The database module 124b may be a structured query language (SQL) database (e.g., a PostgreSQL database, a MySQL database, an Oracle database, etc.) or another type of database (e.g., a not only SQL (NoSQL) database). The database module 124b may include a library of customers and organization credentials for use by the Zeus admin tools module 124a. In some aspects, the database module 124b may be located on the enterprise host 120 within a Dockers container. It should be understood that while depicted on the enterprise host 120 the database module 124b may also be implemented at a remote location such as a cloud service provider (e.g., Amazon Web Services (AWS), Salesforce, Microsoft Azure, or the like).

In another aspect, the database module 124b may store the provisioning workbook and/or configuration data corresponding to the provisioning workbook imported by the Zeus admin tools module 124a. The database module 124a may enable the exemplary computing environment 100 to store and manage the configuration data for each customer and respective customer tenant.

In yet another aspect, the database module 124b may store an API call 128-n before and/or after it is transmitted to a customer tenant 130.

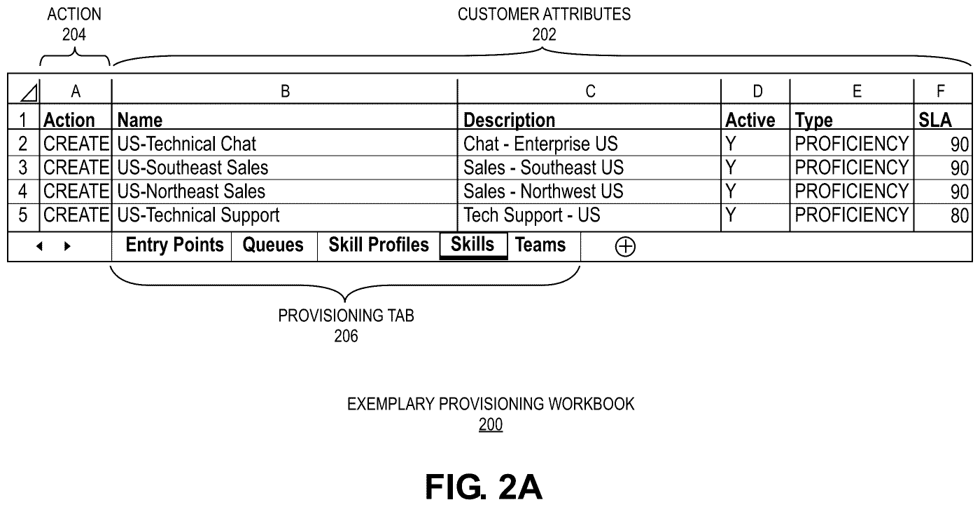

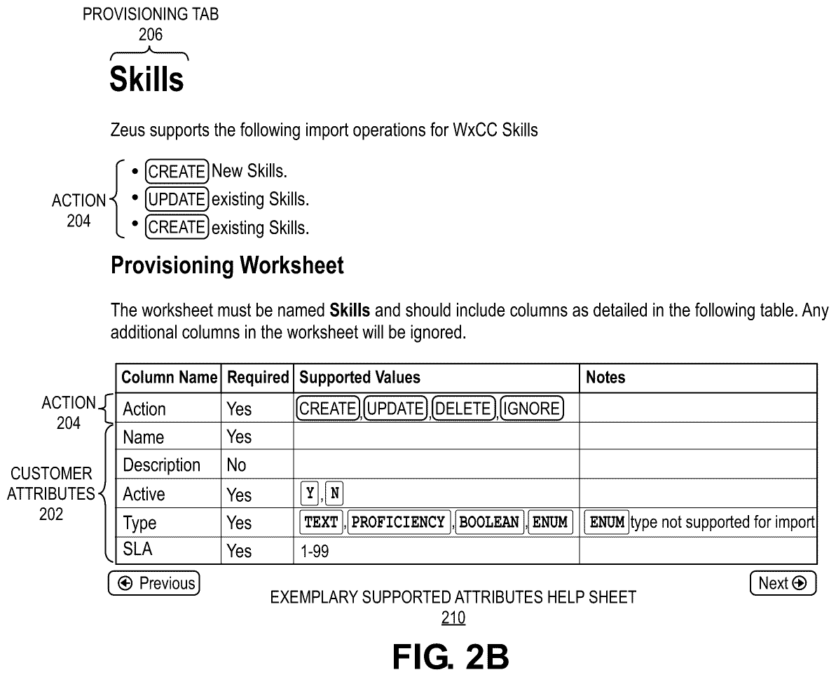

The help module 124c may generally provide help documentation and step by step guidelines for an administrative user to employ the present techniques. The help module 124c may be generated, at least in part, by MkDocs to provide documentation of the Zeus admin tools module 124a and its functionality, among other things. The help module 124c may include a supported data help sheet which lists the supported customer attributes for a particular provisioning tab and customer tenant 130. An exemplary supported data help sheet is discussed below in reference to FIG. 2B.

In yet another aspect, the help module 124c may generate help information pertaining to a customer tenant. The help module 124c may include information (e.g., a step by step list) for authenticating a particular cloud services provider. In another aspect, the help module 124c may include information such as how to import a provisioning workbook, how to browse the configuration data, and/or how to export a provisioning workbook.

The API generation module 124d may process the provisioning workbook and transform the provisioning workbook to an API call 128-n to be transmitted to the customer tenant 130 in the remote telephony environment 150.

In one aspect, the API generation module 124d may transmit the API call 128-n to the customer tenant 130 via the electronic network 140.

In another aspect, the API generation module 124d may not transmit the API call 128-n, that is another module (e.g., the Zeus admin tools module 124a) may transmit the API call 128-n to the customer tenant 130.

In yet another aspect, the API call 128-n may be modified by an administrative user in response to an improper import (e.g., the administrative user must change the action from the provisioning workbook) or otherwise.

In another aspect, the API generation module 124d may utilize configuration data for the API call 128-n.

### Exemplary Customer Tenant

The customer tenant 130 may include any number of cloud collaboration solution providers (e.g., Zoom Contact Center, Zoom Phone, Webex Contact Center, Webex Calling, Five9 Contact Center, Microsoft Teams, etc.). The customer tenant may include and/or otherwise utilize one or more computing devices (e.g., on-premise server(s), cloud-based server(s), desktop/laptop computers, smartphones and/or other smart devices, or the like). The customer tenant 130 may include a memory 132, a customer tenant API 134, and a NIC (Network Interface Card) 136. The memory 132 may include one or more persistent memories (e.g., a hard drive/solid state memory) and may store a customer tenant API 134. The NIC 116 of the customer tenant 130 may include any suitable network interface controller(s), such as wired/wireless controllers (e.g., cellular wireless controllers, Ethernet controllers, etc.), and facilitate bidirectional/multiplexed networking over the network 140 between the customer tenant 130 and other components of the exemplary computing environment 100.

In one aspect, the customer tenant 130 using the customer tenant API 134 receives a transmission from the enterprise host 120 via the network 140. The customer tenant API 134 may include one or more sets of computer-executable instructions for integrating the present techniques through the use of one or more APIs. In some aspects, the API generation module 124d may be used to transmit an API call 128-n using the customer tenant API 134 by which the customer tenant 130 may use the customer attribute transmitted by the Zeus admin tools module 124a in order to deploy a remote telephony environment, in some aspects.

In another aspect, the customer tenant API 134 may create, update, delete, or ignore customer attributes based on the API call 128-n transmitted by the enterprise host 120.

In yet another aspect, the customer tenant 130 may be included in a remote data center (e.g., a cloud computing environment, a public cloud, a private cloud, hybrid cloud, etc.) and/or a remote telephony environment 150.

In operation, an administrative user may create an organization credential using the Zeus admin tools module 124a. An administrative user may import the provisioning workbook 114 from the customer 110 to the Zeus admin tools module 124a on the enterprise host 120 via the electronic network 140. The Zeus admin tools module 124a processes the provisioning workbook and generates configuration data corresponding to the provisioning workbook. The API generation module 124d may transform the provisioning workbook into an API call 128-n to be transmitted to the customer tenant 130 via the electronic network 140.

The configuration data corresponding to the provisioning workbook 114 may be stored on the database module 124b. The configuration records corresponding to the provisioning workbook 114 are transmitted to the customer tenant 130 via the electronic network 140 using the customer tenant API 134, enabling a remote telephony environment to be provisioned.

The administrative user may read, update, delete, or ignore customer attributes in the configuration data corresponding to the provisioning workbook 114 using the Zeus admin tools module 124a. The administrative user may also browse through the configuration data corresponding to the provisioning workbook 114 to view and analyze the customer attributes. Furthermore, the configuration data may be exported from the Zeus admin tools module 124a for various purposes such as to transmit to a customer to fill out.

The computing environment 100 provides an efficient and automated way to handle the provisioning of remote telephony environments. By utilizing the Zeus web tools and the provisioning workbook, the administrative user may streamline the process and minimize manual data entry. This results in quicker and more accurate deployments compared to traditional manual methods. The computing environment 100 allows for collaboration between the administrative user and the customer. The customer may fill out the provisioning workbooks, which saves time and reduces the need for extensive data collection by the administrative user. This collaborative approach helps enforce customer data standards and best practices, leading to improved efficiency and cost savings for both the administrative user and the customer.

The example of FIG. 1 is for illustrative purposes, and it should be appreciated that many alternative configurations are envisioned. A wide array of devices, potentially of different types/configurations, may be utilized using the present techniques.

### Exemplary Provisioning Workbook and Supported Data

FIGS. 2A and 2B depict an exemplary provisioning workbook 200 and exemplary supported attributes help sheet 210 in which various embodiments and/or techniques of the present disclosure may be implemented, in some aspects. Generally, the exemplary provisioning workbook 200 and exemplary supported attributes help sheet 210 may include customer attributes 202, an action 204, and a provisioning tab 206.

In one aspect, the exemplary provisioning workbook 200 may be a Microsoft Excel spreadsheet. In other aspects the provisioning workbook 200 may be an open source or proprietary spreadsheet (e.g., LibreOffice Calc, Google Sheets, Smartsheet, Knack, Tableau Public, Power BI Desktop, etc.). The exemplary provisioning workbook 200 may be sent to a customer 110 with provisioning tabs 206 and customer attributes 202 (e.g., a top row of a spreadsheet, headers, etc.) for the customer 110 to fill out the blank rows and/or columns corresponding to the customer attributes 202 (e.g., an organizations users, devices, interactive voice responses (IVR's), etc.).

In another aspect, the customer attributes 202 may generally include the users, devices, and IVR's of a particular customer. In other aspects, the customer attributes 202 may be a user name, email, first name, last name, extension, permissions, name, description, type, use timer, attempts, timer, message of the day, voicemail, active, service level agreement (SLA), skills, channel type, entry point type, time zone, overflow number, subscription ID, maximum active contacts, control flow, queue type, agents, skill profile name, multimedia profile name, desktop layout name, capacity, directory number (DN), site name, team type, team status, new extension, phone numbers, site, calling plans, address line 1, address line 2, city, state, zip, country, MAC address, new MAC address, template, assignee, new name, parent location, public IP, private IP, basic service set identifier (BSSID), emergency location information number (ELIN), strict match, license type, department, role, company, job title, language, location, manager, pronouns, pronouns option, voicemail enable, transfer site, auto receptionist, voicemail enable, call forwarding enable, call forwarding type, or any other similar customer attributes.

As discussed, in one aspect, one provisioning tab 206 (e.g., skills) may have a particular set of customer attributes 202 associated with it (e.g., action, name, description, active, type, and SLA) based on the customer tenant 130 (e.g., Webex Contact Center) while a second provisioning tab 206 (e.g., skills) for another customer tenant 130 (e.g., Five9) may have another set of customer attributes 202 (e.g., name, description, message of the day, and voicemail) associated with the provisioning tab 206 despite sharing the same name. Moreover, two different provisioning tabs 206 for the same or different customer tenants 130 may contain the same or different customer attributes 202 depending on the customer tenant 130 and configuration, in some aspects.

In yet another aspect, an action 204 may be create, update, delete, or ignore corresponding to a requested change of the customer attributes 204 in the remote telephony environment.

As discussed, in another aspect, a provisioning tab 206 may be one of: entry points, queues, skill profiles, skills, teams, common areas, devices, emergency locations, phone numbers, phone users, sites, templates, meeting users, dispositions, prompts, users, permission profiles, data, or the like. The provisioning tab 206 may be specific to a particular customer tenant 130 (e.g., Webex Contact Center) such that in one aspect, the provisioning tab 206 to be used in the provisioning workbook 114 to be used may have one set of provisioning tabs 206 (e.g., skills, skill profiles, teams, entry points, queues) while another cloud solutions provider (e.g., Zoom Contact Center) may have a different set of provisioning tabs 206 (e.g., common areas, devices, emergency locations, phone numbers, phone users, sites, templates, meeting users).

In another aspect, the exemplary supported data help sheet 210 may assist an administrative user or the customer 110 with ensuring the provisioning worksheet 114 is properly filled out. For example, the exemplary supported data help sheet 210 may include information on the customer attributes 202 supported values (e.g., Y or N, text, proficiency, Boolean, enum, values from 1-99, etc.), whether particular customer attributes 202 are required, and any other notes for a specific provisioning tab 206 (e.g., skills).

### Exemplary Computer Implemented Method

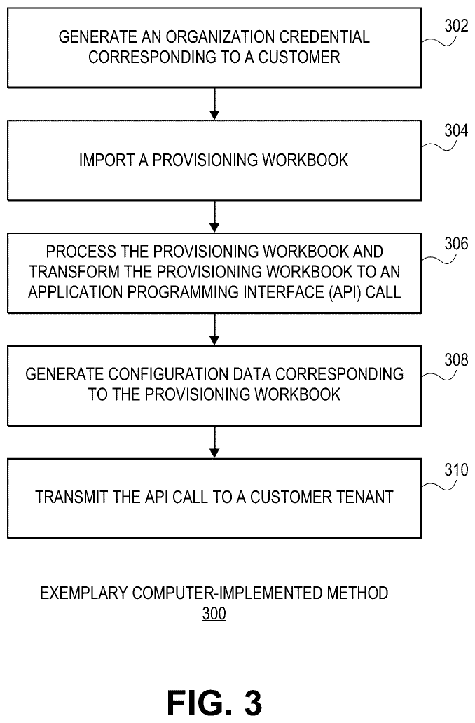

FIG. 3 depicts an exemplary computer-implemented method 300, according to some aspects. The method 300 may be implemented by the enterprise host 120 of FIG. 1, in some aspects.

The method 300 may include creating an organization credential corresponding to a customer (block 302). In one aspect, an organization credential creation may include authenticating via one or more authentication methods (e.g., OAuth, refresh tokens, OpenID Connect, etc.). In other aspects, the method 300 may authenticate via API authentication methods (e.g., via cookies, public key certificates, etc.). In still further aspects (e.g., multi-factor authentication aspects), the method 300 may include receiving one-time use passwords from a particular customer and/or a particular customer tenant (e.g., Zoom Contact Center, Zoom Phone, Webex Contact Center, Webex Calling, Five9 Contact Center, Microsoft Teams, etc.).

The method 300 may include importing a provisioning workbook (block 304). In one aspect, the provisioning workbook 114 may be a Microsoft Excel spreadsheet that is dragged or browsed to and imported into the Zeus admin tools module 124a.

The method 300 may include processing the provisioning workbook and transforming the provisioning workbook to an application programming interface (API) call (block 306). In one aspect, the API generation module 124d reads the provisioning workbook 114 and modifies the customer attributes 202 so that configuration data corresponding to the provisioning workbook 114 can be generated in the form of an API call 128-n to be transmitted to a customer tenant. In another aspect, configuration data may be stored on the database module 124b. In yet another aspect, the Zeus admin tools module 124a may read the provisioning workbook 114 and the API generation module 124d may process the provisioning workbook 114. While particular blocks of the method 300 may be implemented using the Zeus admin tools module 124a of FIG. 1, in some aspects, it should be understood that any suitable module (e.g., API generation module 124d, database module 124b) may implement the method 300, in some aspects.

The method 300 may include generating configuration data corresponding to the provisioning workbook (block 308). In one aspect, the administrative user may modify the configuration action that is generated from the corresponding provisioning workbook as needed.

The method 300 may include transmitting the configuration data corresponding to the provisioning workbook to a customer tenant (block 310). In one aspect, the enterprise host 120 using the API generation module 124d transmits an API call 128-n to the customer tenant 130 via the electronic network 140. In another aspect, the configuration data may be received by the customer tenant API 134 which may be a proprietary API set up by the cloud services provider to allow for modification of a contact center, in some aspects.

While the method 300 may be implemented by the enterprise host 120 of FIG. 1, in some aspects, it should be understood that any suitable computing device may implement the method 300, in some aspects.

### Exemplary Organization Credential and Method

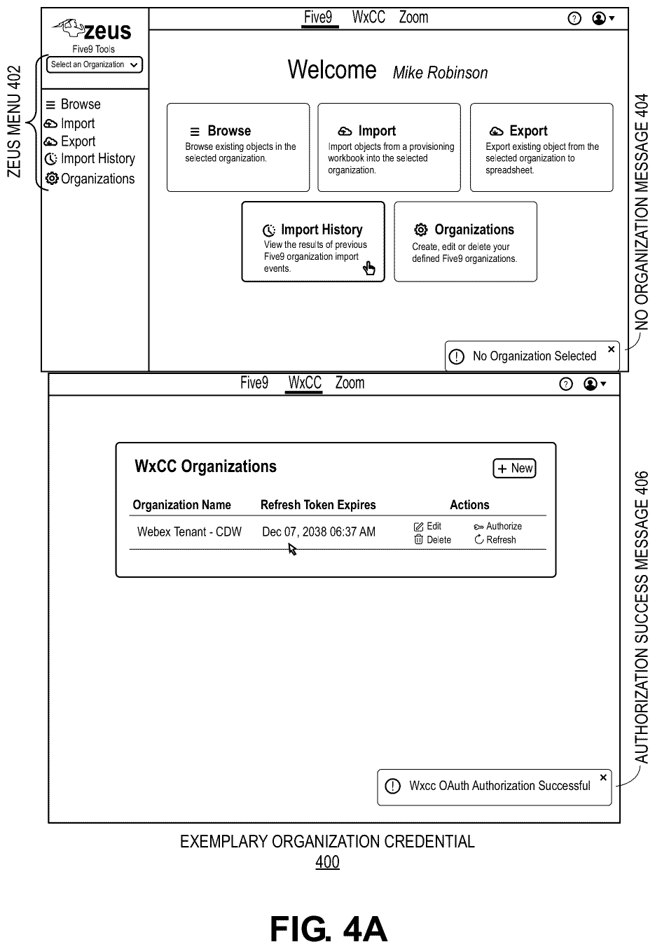

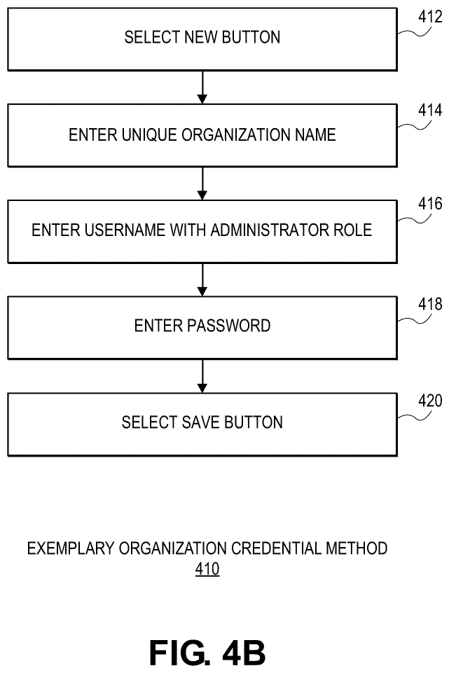

FIGS. 4A and 4B depict an exemplary organization credential 400 and method 410 in which various embodiments and/or techniques of the present disclosure may be implemented, in some aspects. Generally, the exemplary organization credential 400 may include a Zeus menu 402, a no organization message 404, and an authorization success message 406.

The method 410 may include selecting a new button (block 412).

The method 410 may include entering a unique organization name (block 414).

The method 410 may include entering a username with administrator role (block 416).

The method 410 may include entering a password (block 418).

The method 410 may include selecting a save button (block 420).

In one aspect, the Zeus menu 402 may be the main navigational tool for the Zeus admin tools module 124a.

In another aspect, the no organization message 404 may indicate that the Zeus admin tools module 124a cannot perform functionality (e.g., importing, browsing, exporting, etc.) until an organization credential is created and selected in the Zeus menu 402.

In yet another aspect, the method 410 may include authenticating via on OAuth token or a refresh token. In other aspects, the method 410 may include more or less steps for authenticating an organization credential using other similar methods (JSON token, API keys, session tokens, etc.).

### Exemplary Import and Method

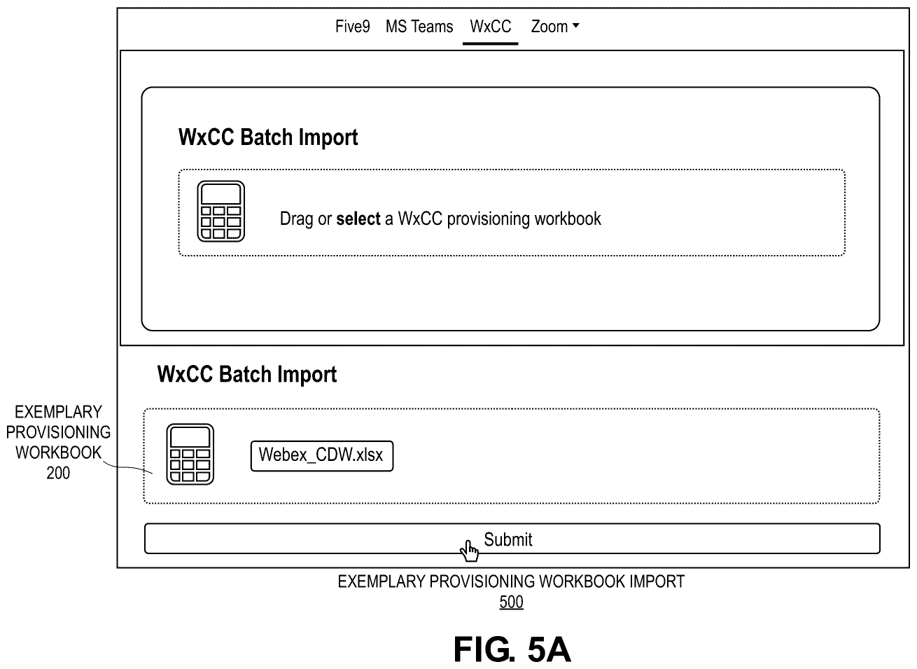

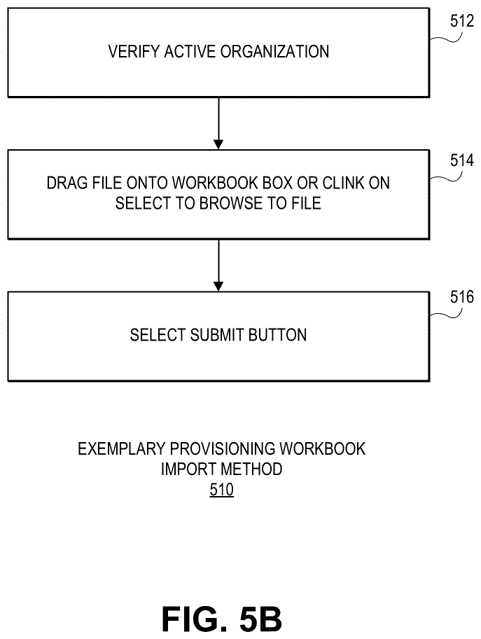

FIGS. 5A and 5B depict an exemplary provisioning workbook import 500 and method 510 in which various embodiments and/or techniques of the present disclosure may be implemented, in some aspects. Generally, the exemplary provisioning workbook import 500 may include the exemplary provisioning workbook 200.

The method 510 may include verifying an active organization (block 512).

The method 510 may include dragging a file onto a workbook box or selecting select to browse to a file (block 514).

The method 510 may include selecting a submit button (block 516).

In one aspect, verifying an active organization may include selecting a desired organization from the Zeus menu 402.

In another aspect, the method 510 may include dragging or selecting an audio prompts file for importing.

### Exemplary Configuration Data Submission and Method

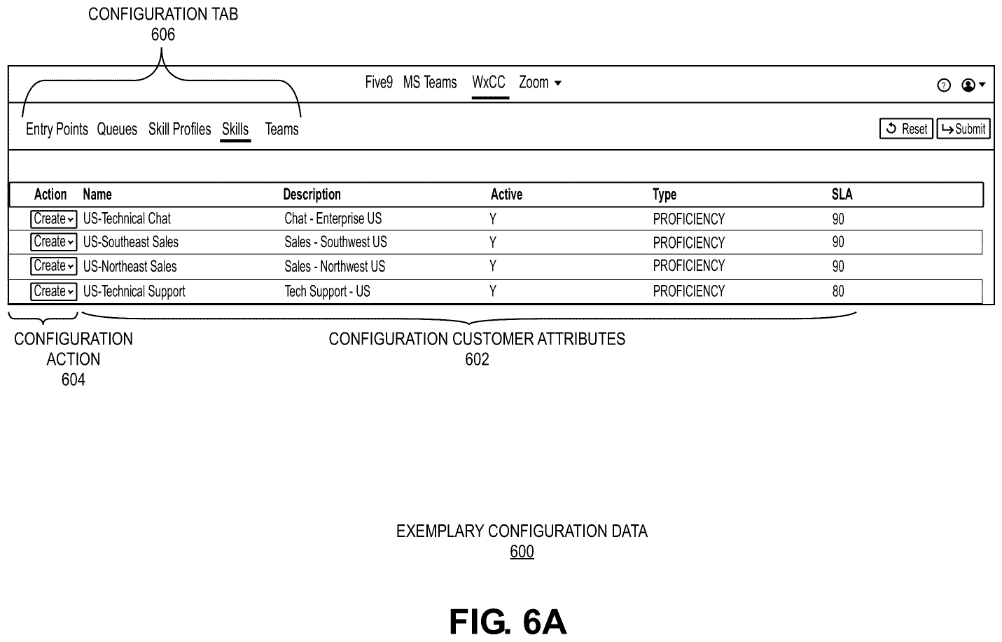

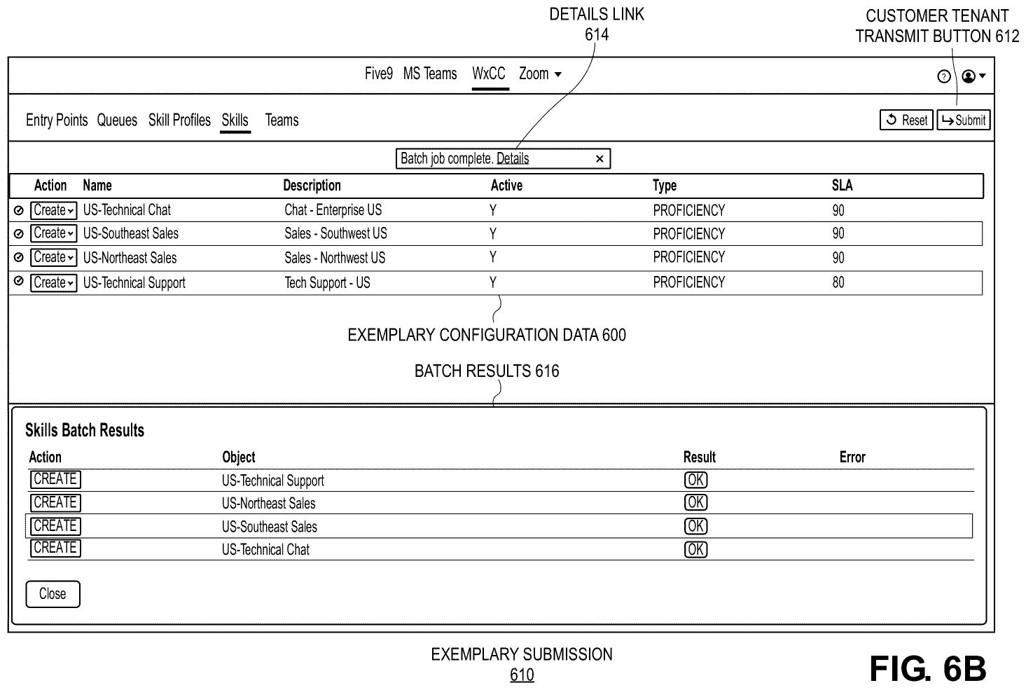

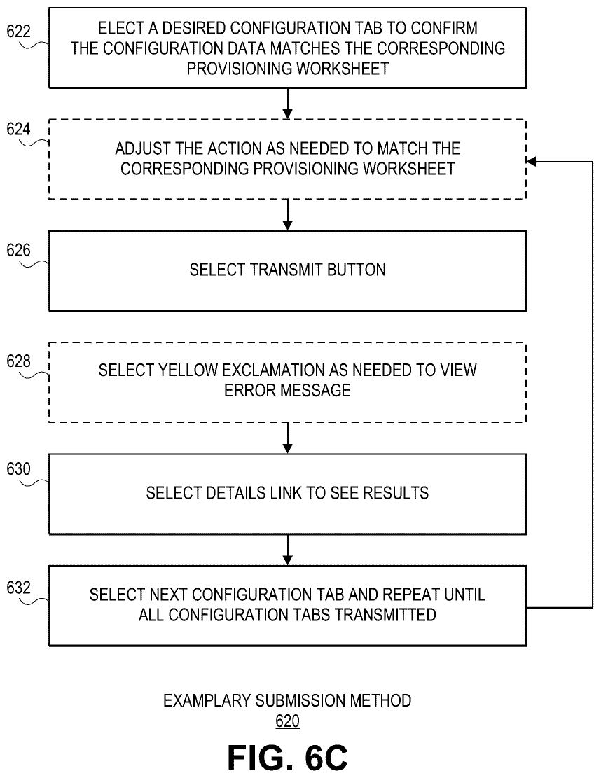

FIG. 6A depicts exemplary configuration data 600 in which various embodiments and/or techniques of the present disclosure may be implemented, in some aspects. Generally, the exemplary configuration data 600 may include configuration customer attributes 602, a configuration action 604, and a configuration tab 606.

FIGS. 6B and 6C depict an exemplary submission 610 and method 620 in which various embodiments and/or techniques of the present disclosure may be implemented, in some aspects. Generally, the exemplary submission 610 may include the exemplary configuration data 600, a customer tenant transmit button 612, a details link 614, and batch results 616.

The method 620 may include selecting a desired configuration tab to confirm the configuration data matches the corresponding provisioning worksheet (block 622).

The method 620 may include adjusting the action as needed to match the corresponding provisioning worksheet (block 624).

The method 620 may include selecting a transmit button (block 626).

The method may include selecting a yellow exclamation as needed to view an error message (block 628).

The method may include selecting a details link to see results (block 630).

The method may include selecting a next configuration tab and repeating until all configuration tabs are transmitted (block 632).

In one aspect, the method 620 may be iterated until all configuration customer attributes 602 has been transmitted to the customer tenant 130.

### Exemplary Browsing, Event History, and Export and Method

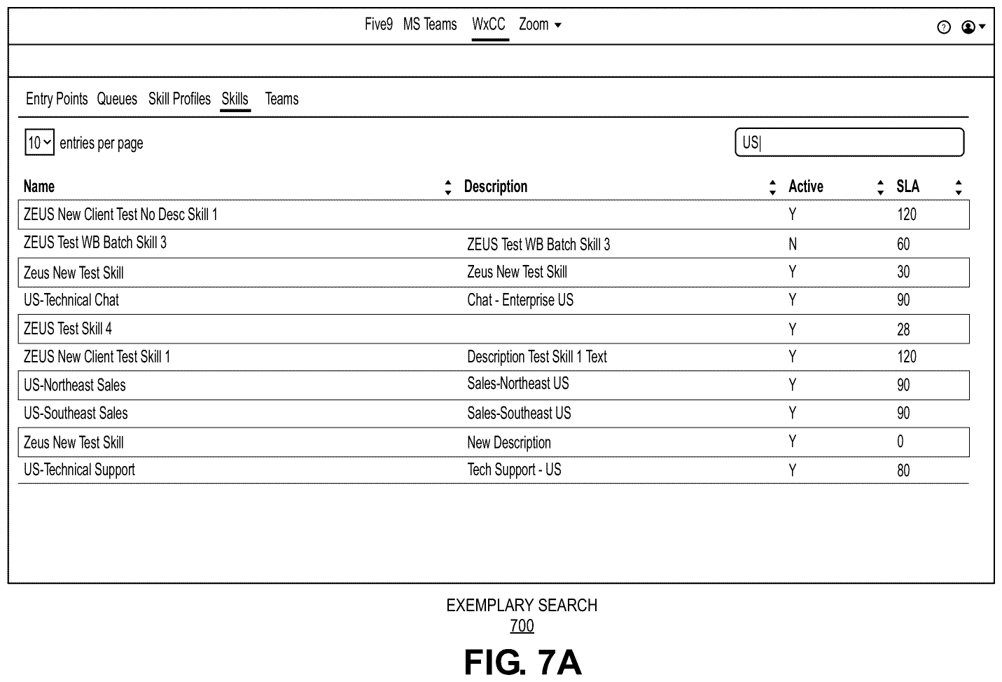

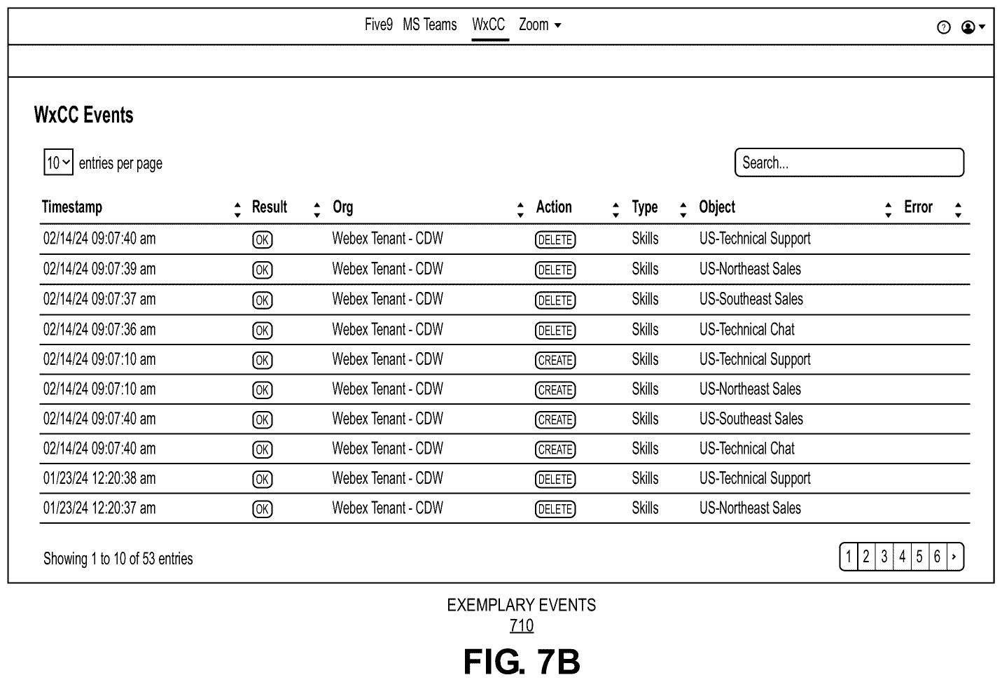

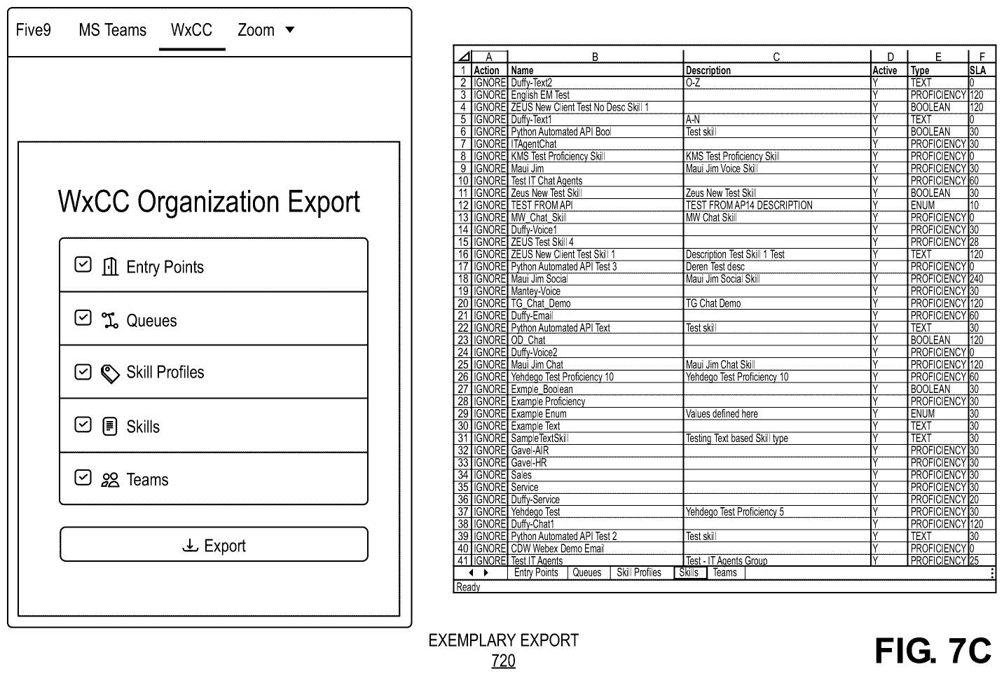

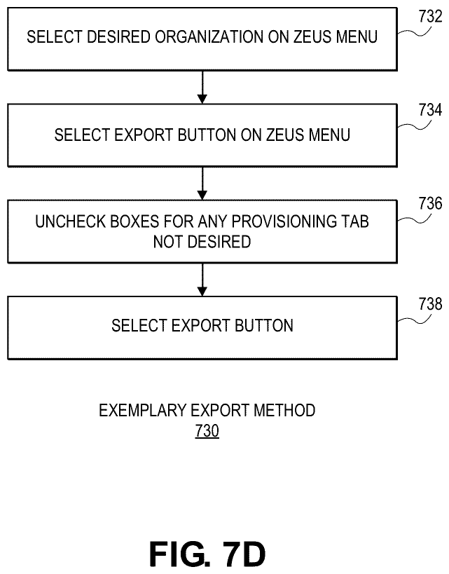

FIGS. 7A, 7B, 7C, and 7D depict an exemplary search 700, exemplary events 710, exemplary export 720, and an exemplary export method 730 in which various embodiments and/or techniques of the present disclosure may be implemented, in some aspects.

The method 730 may include selecting a desired organization on a Zeus menu (block 732).

The method 730 may include selecting an export button from the Zeus menu (block 734).

The method 730 may include unchecking boxes for any provisioning tab not desired (block 736).

The method may include selecting export (block 738).

In one aspect, the method 730 may be employed to obtain a provisioning workbook 114 to be sent to the customer 110 to fill with their respective customer attributes 202.

Of course, the applications and benefits of the systems, methods and techniques described herein are not limited to only the above examples. Many other applications and benefits are possible by using the systems, methods and techniques described herein.

Furthermore, when implemented, any of the methods and techniques described herein or portions thereof may be performed by executing software stored in one or more non-transitory, tangible, computer readable storage media or memories such as magnetic disks, laser disks, optical discs, semiconductor memories, biological memories, other memory devices, or other storage media, in a RAM or ROM of a computer or processor, etc.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects:
1. A computer-implemented method for assisting an administrative user with providing a remote telephony environment, comprising: generating, by one or more processors, an organization credential corresponding to a customer; importing, via an electronic network, a provisioning workbook corresponding to a remote telephony environment; processing, by the one or more processors, the provisioning workbook, wherein the processing includes transforming the provisioning workbook into an application programming interface (API) call corresponding to the remote telephony environment; generating, by the one or more processors, configuration data corresponding to the provisioning workbook; and transmitting, to a customer tenant via the electronic network, the API call corresponding to the remote telephony environment.
2. The computer implemented method of aspect 1, wherein the provisioning workbook and configuration data include an action of at least one of: creating, updating, deleting, or ignoring.
3. The computer implemented method of aspects 1 or 2, further comprising: importing, via the electronic network, an audio prompts file.
4. The computer implemented method of any one of aspects 1 to 3, wherein the organization credential includes at least one of an OAuth token or a refresh token.
5. The computer implemented method of any one of aspects 1 to 4, further comprising: searching, by the one or more processors, the configuration data corresponding to the provisioning workbook; generating, by the one or more processors, an event history; and exporting, by the one or more processors, a provisioning workbook.
6. The computer implemented method of any one of aspects 1 to 5, further comprising: generating, by the one or more processors, a details page with an outcome of the transmission.
7. The computer implemented method of any one of aspects 1 to 6, wherein the provisioning workbook and the configuration data include one or more of: entry points, queues, skill profiles, skills, teams, common areas, devices, emergency locations, phone numbers, phone users, sites, templates, meeting users, dispositions, prompts, users, permission profiles, or data.
8. A computing system for assisting an administrative user with providing a remote telephony environment, comprising: one or more processors; and one or more memories having stored thereon instructions that, when executed by the one or more processors, cause the system to: generate, by the one or more processors, an organization credential corresponding to a customer; import, via an electronic network, a provisioning workbook corresponding to a remote telephony environment; process, by the one or more processors, the provisioning workbook, wherein the process includes transforming the provisioning workbook into an application programming interface (API) call corresponding to the remote telephony environment; generate, by the one or more processors, configuration data corresponding to the provisioning workbook; and transmit, to a customer tenant via the electronic network, the API call corresponding to the remote telephony environment.
9. The computing system of aspect 8, wherein the provisioning workbook and configuration data include an action of at least one of: creating, updating, deleting, or ignoring.
10. The computing system of aspects 8 or 9, the one or more memories having stored thereon instructions that, when executed, cause the one or more processors to: import, via the electronic network, an audio prompts file.
11. The computing system of any one of aspects 8 to 10, wherein the organization credential includes at least one of an OAuth or a refresh token.
12. The computing system of any one of aspects 8 to 11, the one or more memories having stored thereon instructions that, when executed, cause the one or more processors to: search, by the one or more processors, the configuration data corresponding to the provisioning workbook; generate, by the one or more processors, an event history; and export, by the one or more processors, a provisioning workbook.
13. The computing system of any one of aspects 8 to 12, the one or more memories having stored thereon instructions that, when executed, cause the one or more processors to: generate, by the one or more processors, a details page with an outcome of the transmission.
14. The computing system of any one of aspects 8 to 13, wherein the provisioning workbook and the configuration data include one or more of: entry points, queues, skill profiles, skills, teams, common areas, devices, emergency locations, phone numbers, phone users, sites, templates, meeting users, dispositions, prompts, users, permission profiles, or data.
15. A non-transitory computer-readable medium having stored thereon computer-executable instructions that, when executed, cause a computer to: generate, by one or more processors, an organization credential corresponding to a customer; import, via an electronic network, a provisioning workbook corresponding to a remote telephony environment; process, by the one or more processors, the provisioning workbook, wherein the process includes transforming the provisioning workbook into an application programming interface (API) call corresponding to the remote telephony environment; generate, by the one or more processors, configuration data corresponding to the provisioning workbook; and transmit, to a customer tenant via the electronic network, the API call corresponding to the remote telephony environment.
16. The non-transitory computer-readable medium of aspect 15, wherein the provisioning workbook and configuration data include an action of at least one of: creating, updating, deleting, or ignoring.
17. The non-transitory computer-readable medium of aspects 15 or 16, having stored thereon instructions that, when executed, cause a computer to at least: import, via the electronic network, an audio prompts file.
18. The non-transitory computer-readable medium of any one of aspects 15 to 17, wherein the organization credential includes at least one of an OAuth or a refresh token.
19. The non-transitory computer-readable medium of any one of aspects 15 to 18, having stored thereon instructions that, when executed, cause a computer to at least: search, by the one or more processors, the configuration data corresponding to the provisioning workbook; generate, by the one or more processors, an event history; and export, by the one or more processors, a provisioning workbook.
20. The non-transitory computer-readable medium of any one of aspects 15 to 19, having stored thereon instructions that, when executed, cause a computer to at least: generate, by the one or more processors, a details page with an outcome of the transmission.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, and/or may be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single computer, but deployed across a number of computers. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single computer, but deployed across a number of computers. In some example embodiments, the one or more processors or processor-implemented modules may be located in a single geographic location (e.g., within an offices enterprise server environment). In other example embodiments, the one or more processors or processor-implemented modules may be distributed across a number of geographic locations (e.g., various cloud computing servers).

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “determining,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other components that receive, store, transmit, or display information.

As used herein any reference to “one embodiment,” “a particular embodiment,” “an embodiment,” or the like means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other (e.g., communicatively coupled). The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for assisting an administrative user with providing a remote telephony environment, comprising:
generating, by one or more processors, an organization credential corresponding to a customer;
importing, via an electronic network, a provisioning workbook corresponding to a remote telephony environment;
processing, by the one or more processors, the provisioning workbook,
wherein the processing includes transforming the provisioning workbook into an application programming interface (API) call corresponding to the remote telephony environment;
generating, by the one or more processors, configuration data corresponding to the provisioning workbook; and
transmitting, to a customer tenant via the electronic network, the API call corresponding to the remote telephony environment.

2. The computer implemented method of claim 1, wherein the provisioning workbook and configuration data include an action of at least one of: creating, updating, deleting, or ignoring.

3. The computer implemented method of claim 1, further comprising:
importing, via the electronic network, an audio prompts file.

4. The computer implemented method of claim 1, wherein the organization credential includes at least one of an OAuth token or a refresh token.

5. The computer implemented method of claim 1, further comprising:
searching, by the one or more processors, the configuration data corresponding to the provisioning workbook;
generating, by the one or more processors, an event history; and
exporting, by the one or more processors, a provisioning workbook.

6. The computer implemented method of claim 1, further comprising:
generating, by the one or more processors, a details page with an outcome of the transmission.

7. The computer implemented method of claim 1, wherein the provisioning workbook and the configuration data include one or more of: entry points, queues, skill profiles, skills, teams, common areas, devices, emergency locations, phone numbers, phone users, sites, templates, meeting users, dispositions, prompts, users, permission profiles, or data.

8. A computing system for assisting an administrative user with providing a remote telephony environment, comprising:
one or more processors; and
one or more memories having stored thereon instructions that, when executed by the one or more processors, cause the system to:
generate, by the one or more processors, an organization credential corresponding to a customer;
import, via an electronic network, a provisioning workbook corresponding to a remote telephony environment;
process, by the one or more processors, the provisioning workbook,
wherein the process includes transforming the provisioning workbook into an application programming interface (API) call corresponding to the remote telephony environment;
generate, by the one or more processors, configuration data corresponding to the provisioning workbook; and
transmit, to a customer tenant via the electronic network, the API call corresponding to the remote telephony environment.

9. The computing system of claim 8, wherein the provisioning workbook and configuration data include an action of at least one of: creating, updating, deleting, or ignoring.

10. The computing system of claim 8, the one or more memories having stored thereon instructions that, when executed, cause the one or more processors to:
import, via the electronic network, an audio prompts file.

11. The computing system of claim 8, wherein the organization credential includes at least one of an OAuth or a refresh token.

12. The computing system of claim 8, the one or more memories having stored thereon instructions that, when executed, cause the one or more processors to:
search, by the one or more processors, the configuration data corresponding to the provisioning workbook;
generate, by the one or more processors, an event history; and
export, by the one or more processors, a provisioning workbook.

13. The computing system of claim 8, the one or more memories having stored thereon instructions that, when executed, cause the one or more processors to:
generate, by the one or more processors, a details page with an outcome of the transmission.

14. The computing system of claim 8, wherein the provisioning workbook and the configuration data include one or more of: entry points, queues, skill profiles, skills, teams, common areas, devices, emergency locations, phone numbers, phone users, sites, templates, meeting users, dispositions, prompts, users, permission profiles, or data.

15. A non-transitory computer-readable medium having stored thereon computer-executable instructions that, when executed, cause a computer to:
generate, by one or more processors, an organization credential corresponding to a customer;
import, via an electronic network, a provisioning workbook corresponding to a remote telephony environment;
process, by the one or more processors, the provisioning workbook,
wherein the process includes transforming the provisioning workbook into an application programming interface (API) call corresponding to the remote telephony environment;
generate, by the one or more processors, configuration data corresponding to the provisioning workbook; and
transmit, to a customer tenant via the electronic network, the API call corresponding to the remote telephony environment.

16. The non-transitory computer-readable medium of claim 15, wherein the provisioning workbook and configuration data include an action of at least one of: creating, updating, deleting, or ignoring.

17. The non-transitory computer-readable medium of claim 15, having stored thereon instructions that, when executed, cause a computer to at least:
import, via the electronic network, an audio prompts file.

18. The non-transitory computer-readable medium of claim 15, wherein the organization credential includes at least one of an OAuth or a refresh token.

19. The non-transitory computer-readable medium of claim 15, having stored thereon instructions that, when executed, cause a computer to at least:
search, by the one or more processors, the configuration data corresponding to the provisioning workbook;
generate, by the one or more processors, an event history; and
export, by the one or more processors, a provisioning workbook.

20. The non-transitory computer-readable medium of claim 15, having stored thereon instructions that, when executed, cause a computer to at least:
generate, by the one or more processors, a details page with an outcome of the transmission.
